(19) United States
(12) Patent Application Publication
(10) Pub. No.: US 2018/0123096 A1
(43) Pub. Date: May 3, 2018

(54) Means for Assembling Cylindrical Batteries into a Modular and Rebuildable Battery Pack

(71) Applicant: Shawn Allan McCarty, Venice, FL (US)

(72) Inventor: Shawn Allan McCarty, Venice, FL (US)

(21) Appl. No.: 15/335,766

(22) Filed: Oct. 27, 2016

(51) Int. Cl. H01M 2/10; H01M 2/20

(52) U.S. Cl. CPC H01M 2/1077; H01M 2220/20; H01M 2/206

(57) ABSTRACT

Lithium batteries of this capacity are typically built of cells that are connected with spot welding. Should one cell fail an entire battery must be discarded. The design of these “Blocs” allows cells to be replaced. The individually replaceable cells allow the battery to be repaired, rebuilt and upgraded unlike spot welded batteries.

The unique open top case design allows the Blocs can be assembled in any configuration. Connections between Blocs are made with conductive plates which can be dissasembled and provide structural support.

The magnets used form button tops for the cells and allow the Blocs to be “snapped” together,

The non-conductive bolts provice compressive force making good electrical connection between the cell, magnets, and rigid parallel plates.

The plastic magnet holders keep the magnets from drifting and isolate the negative charged case from the positive terminal.

Finally the standoffs provide a means for mounting the Blocs to a flat surface or to bolt together using threaded rod to make a battery needing no extra structural support.

### CROSS REFERENCE TO RELATED APPLICATIONS

On December 28, 2015, I applied for a provisional patent for a Modular Rebuildable Case for Cylindrical Battery Cells. The application # is 62/271,785. The EFS ID # is 24466139.

### BACKGROUND AND BRIEF SUMMARY OF INVENTION

I, Shawn Allan McCarty reside at 1540 Queen Road, Venice, Fla. I have designed a means for the assembly of batteries from cylindrical cells. This embodiment allows individual cells to be connected in parallel without spot welding. The cases are then assembled in series or parallel to create a battery pack that can be dissasembled to be repaired or upgraded.

I spent two years trying various ways of assembling cylindrical cells into rebuildable and repairable battery packs. After scores of iterations I built an electric bicycle using my best design and rode 9000 miles looping the USA to test the battery. (https://www.amazon.com/Loop-USA-odyessy-Shawn-McCarty-ebookidp/B017PDCM96) On that journey I conceived the final design that I submit today.

Lithium Battery packs are commonly spot welded together. This makes good connections but the pack is not repairable nor are the cells able to be repurposed. Should one cell fail the entire battery pack must be discarded. So I set out to create an easy to build and repair battery pack. The cells in any battery pack are first assembled into parallel groups, and so this design connects cells in parallel groups. The electrical connections between parallel groups needed to be massive for minimum electrical resistance. This led to an open top design which exposes the connector plate for maximum electrical-contact surface area. The battery needed good structural integrity and mounting flexibility and this led to holes for through bolts.

### PRIOR ART

Patent U.S. Pat. No. 8,361,646 B2 Class H01R12/00 Shows a way of holding cylindrical cells in a container with a perforated flexible metal strip that has magnets attached. The magnets provide the sole force to hold the cells in place. The invention provides for the coupling and uncoupling of cells using electromagnets. I found that magnets alone do not provide sufficient compressive force for a reliable electrical connection. My design differs in that it: A; Relies on through bolts to provide compressive forces. B; Uses a connector plate that has limited flexibility. C; Uses the magnets to create button tops for flat topped cells. D; Uses magnets as a rapid prototyping tool and not as the sole means of providing the compression necessary for a robust electrical connection.

Patent U.S. Pat. No. 8691407B2 Class H01M2/1022. Shows a battery pack using magnetic connections on tabs welded to the battery. My invention avoids welding as a means of connecting cells.

Patent U.S. Pat. No. 9,099,867B2 Class H02J7/00 Shows a method of making battery charger connections using magnets for correct polarity alignment. I use magnets not to determine polarity but to provide a button top and to facilitate assembly.

Patent US6265091B1 Class H01M2/10 It's cells are held in series or parallel with spot welded tabs making it modular only on the battery level, but the cells are not individually replaceable as in my design. There are no magnets or compression bolts and the modules are connected with posts.

Patent US8288035B2 Class H0M2/0245 This battery has a modular case using splines to attach to an adjacent case. The cells are spot welded to tabs within the case making individual cells not replaceable. The spot welded cell groups make electrical contact through springs. I have found springs to be suitable only for low power devices. The cases do not have any method of mounting them. My cases have mounting bolt holes. Their cases use small metal pieces to make connections between cell blocs. My electrical contacts are massive. My case is dramatically simpler and more robust. My cases have the entire positive and negative surface exposed allowing for massive connectivity.

Patent U.S. Pat. No. 6,517,966B1 Class H01M4/661 This patent covers design issues when assembling prismatic cells into a pack. My design is is for cylindrical cells.

### BRIEF DESCRIPTION OF THE DRAWINGS

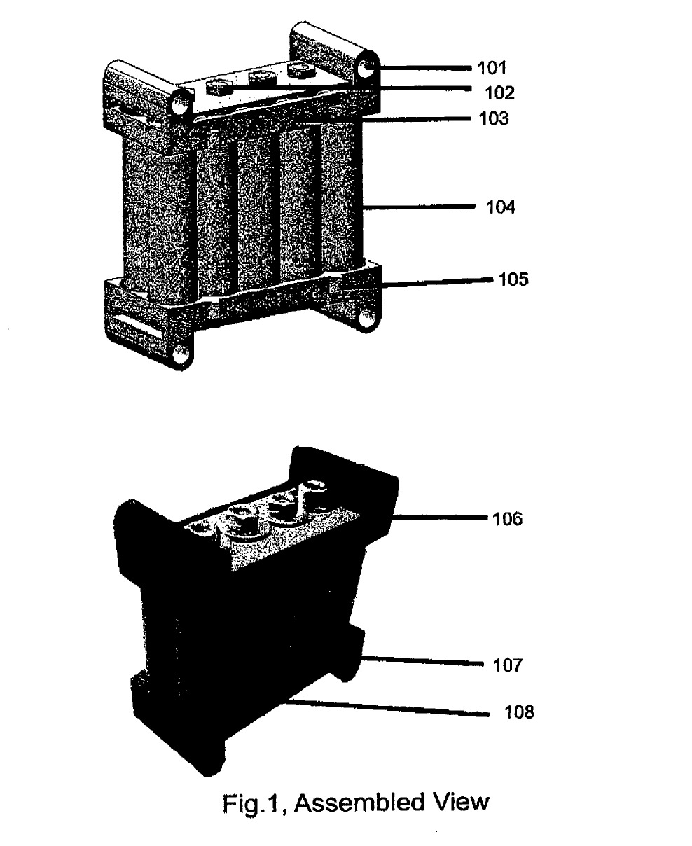

Figure and part numbers are designated with the figure number first followed by the part number. 101 refers to FIG. 1, item 01.

### Sheets

FIG. 1. Shows an assembled view with cells installed and how color is used.

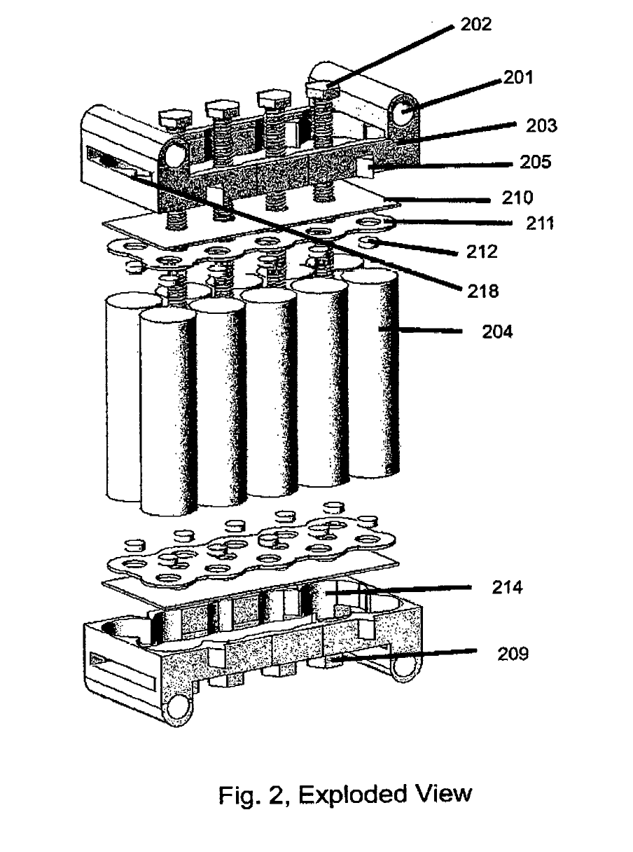

FIG. 2. Shows an exploded view.

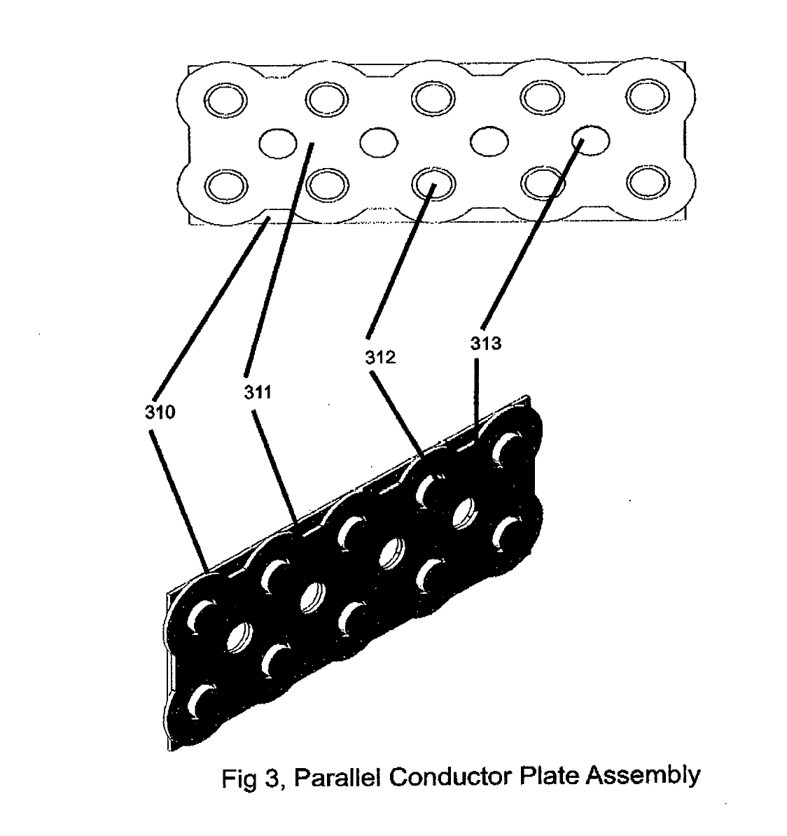

FIG. 3. Shows the components of the Parallel Conductor Plate

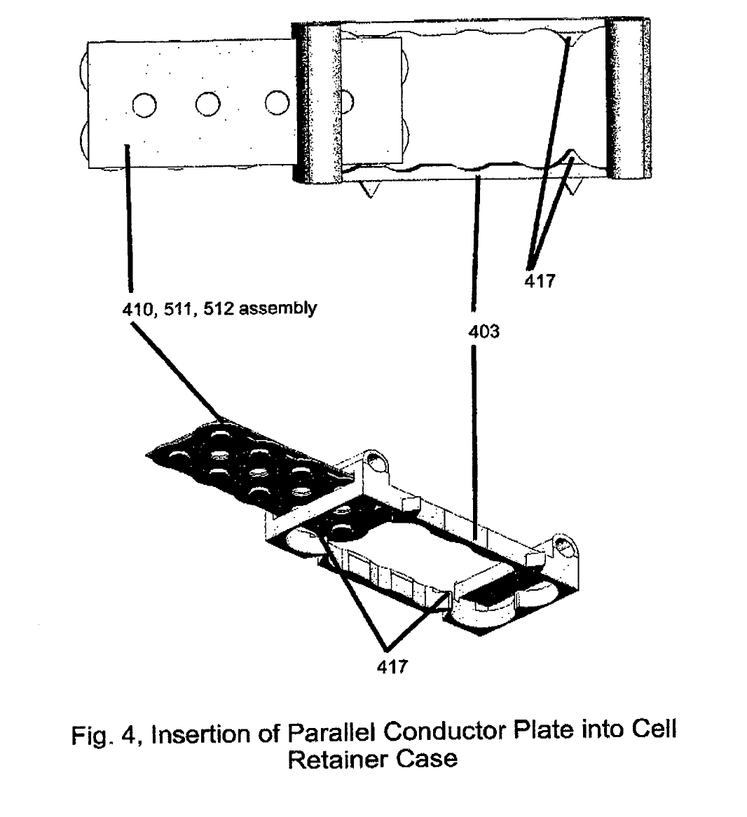

FIG. 4. Shows how to install the Parallel Conductor Plate

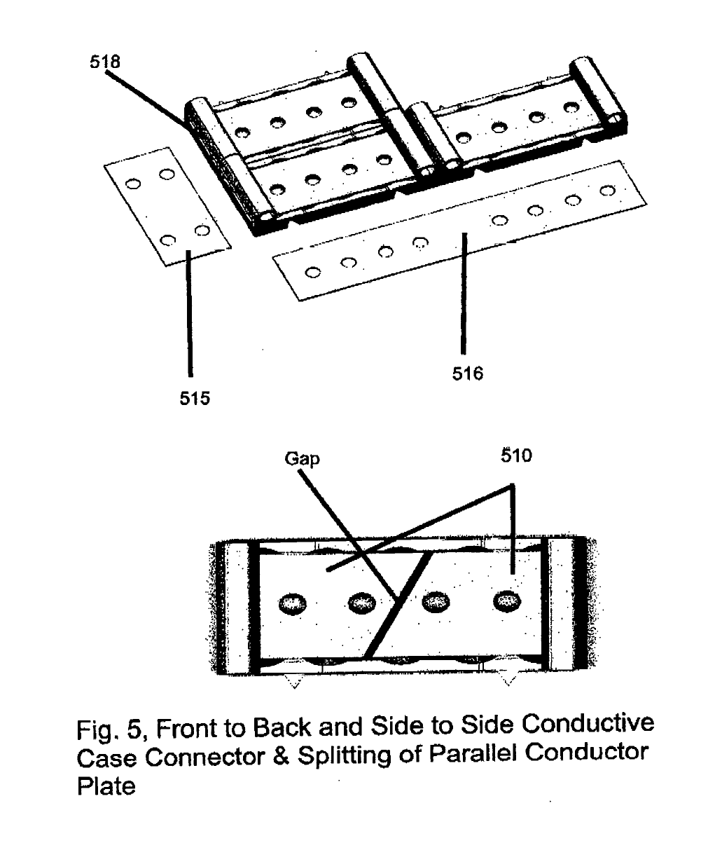

FIG. 5. Shows how Conductive Connectors are used to make front to back or side to side connections between Cell Retainer Case assemblies.

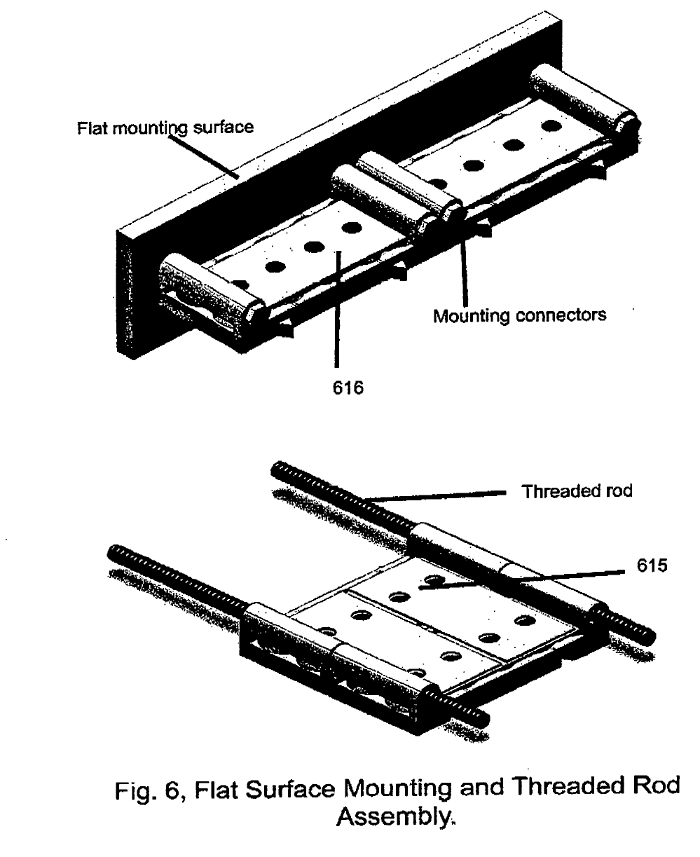

FIG. 6. Shows different methods of mounting and connecting the Cell Retaining Cases.

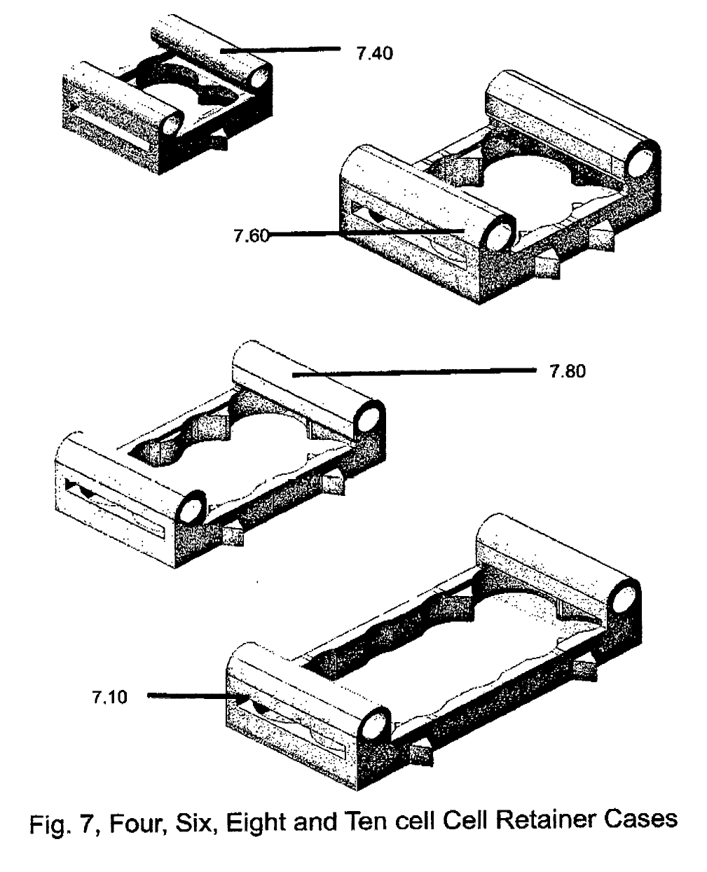

FIG. 7. Shows how the overall design is retained across different amounts of cells connected in parallel.

### PART NUMBERS

### FIG. 1. Assembled View

102 Standoffs with mounting holes

104 Non conductive compressive bolts

106 Parallel Conductor Plate

108 Cell Retainer Case

100 Cells

110 Alignment arrows

120 The color BLACK

112 Alignment notches

122 The color RED

### FIG. 2. Exploded View

204 Non Conductive Compression Bolts

201 Mounting bolt holes

208 Cell Retainer Case

210 Alignment arrows

206 Parallel Conductor Plate

205 Magnet Retainer

207 Neodymium magnets

209 Parallel Conductor Plate insertion slot

200 Cylindrical cells

211 Cell retainer recesses

214 Non-Conductive Compression Bolt Nuts

### FIG. 3. Parallel Conductor Plate Assembly

306 Parallel Conductor Plate

305 Magnet Retainer

307 Neodymium magnets

325 Holes for the passage of the Non Conductive Compression Bolts.

### FIG. 4. Insertion of Parallel Conductor Plate into the Cell Retainer Case

441 Parallel Conductor Plate Assembly

403 Cell Retainer Case

417 Parallel Conductor Plate Assembly insertion guide.

### FIG. 5. Method of connecting parallel groups together

551 Cell Retainer Case Assemblies showing front to back and side to side alignments.

552 Conductive Connector for Front to Back Connections.

553 Conductive Connector for Side to Side Connections.

### FIG. 6. Surface Mounting and Threaded Rod Assembly.

661 Cell retainer assemblys mounted to a flat surface

662 Cell retainer assemblys bolted together with threaded rod. Front to back connector is in place.

### FIG. 7. Four, Six, Eight and Ten Cell Retainer Cases

774 Four cell retainer case

776 Six cell retainer case

778 Eight cell retainer case

770 Ten cell retainer case

### DETAILED DESCRIPTION AND BEST MODE OF IMPLEMENTATION

### Cell Retaining Case

There are two main components of this design. The first is a Cell Retaining Case 108. The Cell Retainer Case has an open top exposing the Parallel Conductor Plate 106 creating the largest possible electrical connection surface area. The Cell Retaining Case has two Standoffs 102 which allow the case to be mounted to another case using threaded rods 662, or to a flat surface 661.

The Cell Retaining Case has alignment notches 112 and arrows 110. Said case has a plurality of recesses to hold the cylindrical cells loosely in place 211. There is a retainment ledge which keeps the Parallel Conductor Plate from falling out the bottom of the case 417. Standoffs 102 keep the Parallel Conductor Plate from falling out the top of the case.

Slots in both sides of the case 209 allow side to side electrical connections. Front to back electrical connections 552 pass over the lip of the case.

Said cases are sized differently to hold different cell amounts but follow the same design 774, 776, 778, 770.

### Parallel Conductor Plate

The second component is the Parallel Conductor Plate Assembly, FIG. 3. Said assembly connects the individual cells in parallel. The aforementioned Assembly consists of three parts:
1. A Parallel Conductor Plate 206, 306, which connects the positive terminals of the cells together and the negative terminals of the cells together.
2. A magnet retainer 205, 305, which keeps the magnets from sliding. It also prevents shorts by providing an insulating barrier between the cell casing and the positive Parallel Connector Plate.
3. Neodymium magnets corresponding to the number of cells in the assembly 207, 307.

There are holes in the Parallel Conductor Plate 206, 306 to allow for the passage of Non-Conductive Bolts 204 which provide a clamping force on the positive and negative Parallel Conductor Plates. Said Non-Conductive Bolts tighten the connection between the cells 100, the Neodymium Magnets 207, and the Parallel Conductive Plates 206.

The Magnet Retainer 205, 305 is attached to the Parallel Conductive Plate 206, 306 with adhesive. The polarity orientation of the magnets does not matter.

### Operation

Insert a Parallel Conductor Plate Assembly 441 into the Parallel Conductor Plate Insertion Slot 209. The magnets face away from the Standoffs 102. Next insert the cylindrical cells 100 taking care to align the negative terminal of the cells with the Black Cell Retainer Case Assembly 120 and the positive terminal of the cells with the Red Cell Retainer Case Assembly 122. The neodynium magnets 207 will hold the cells in place and the Magnet Retainer 205 will prevent the magnets from moving and will insulate the cell's negatively charged outer case from the Parallel Conductor Plates' positive side,

With the cells installed insert the Non-Conductive Compression Bolts 204, attaching a ring terminal to a said bolt to make a connection point for a wire. Before attaching

A modular battery assembly case allowing individual cell replacement comprising:

1. a battery assembly case with all of these features: an open top, standoffs, and a conductive insert.

2. The invention of claim 1 including a means of making electrical connections in said case by combining magnetic and compression forces.
